(19) United States
(12) Patent Application Publication
(10) Pub. No.: US 2015/0053171 A1
(43) Pub. Date: Feb. 26, 2015

(54) INTERNAL COMBUSTION ENGINE WITH HIGH TEMPERATURE FUEL INJECTION

(71) Applicant: Transonic Combustion, Inc., Camarillo, CA (US)

(72) Inventor: Shizuo Sasaki, Camarillo, CA (US)

(73) Assignee: Transonic Combustion, Inc., Camarillo, CA (US)

(21) Appl. No.: 14/152,895

(22) Filed: Jan. 10, 2014

Related U.S. Application Data
(60) Provisional application No. 61/869,468, filed on Aug. 23, 2013.

(51) Int. Cl. F02B 11/00

(52) U.S. Cl. CPC F02B 11/00
USPC 123/27 R

(57) ABSTRACT

Set forth herein are apparatuses and systems that utilize high temperature fuel injection to eliminate knocking within a combustion systems, and more particularly internal combustion engines. In some embodiments, the combustion system of the present invention can eliminate knocking through the use of high compression ratios and high intake boost pressures. The combustion system can have a high exhaust gas recirculation (EGR) tolerance, as well as an increased range of fuel-air ratio with improved ignitability and increased combustion speed of the system. In some embodiments, combustion in the present invention takes place using a compression ignition process, a spark assisted compression ignition process or a combination thereof.

### CROSS REFERENCE TO RELATED APPLICATIONS

This application claims the benefit of U.S. Provisional Patent Application Ser. No. 61/869,468, to Sasaki, filed on Aug. 23, 2013, and entitled “Internal Combustion Engine With High Temperature Fuel Injection.”

### BACKGROUND OF THE INVENTION

1. Field of the Invention

The present invention relates generally to a system to address ignition deficiencies in combustion systems and more particularly to innovative knock-free internal combustion engines that utilize high temperature fuel injection with high compression ratios and high intake boost pressure.

2. Description of the Related Art

Internal combustion engines burn a fuel-air mixture in a combustion chamber. Ideally, this combustion process occurs in an orderly and controlled fashion. For this to occur, the fuel-air charge should be ignited by a spark plug at a precise time in the piston cycle. However, often times one or more pockets of fuel-air mixture explode before or after the ideal spark ignition time, which is a process commonly known as knocking.

Specifically, knocking occurs when the peak combustion of the fuel-air mixture does not occur at the ideal moment in the piston cycle. This can result in a shock wave forming within the combustion chamber. Additionally, this can cause pressure in the combustion chamber to increase dramatically. Along with increased engine noise, knocking can also cause damage to the engine.

Knocking also presents a problem when it is desired to increase the compression ratio and/or the boost pressure of the intake. These strategies are important in maintaining high fuel efficiency, or reducing CO₂ emissions. Furthermore, in order to create stratified charge combustion, it is important to have combustion stability which limits the fuel-air ratio and/or the exhaust gas recirculation (EGR) rate.

There have been several prior attempts to solve the aforementioned problems. One attempt was a spark ignition stratified charge engine with a low compression ratio and/or a limited intake boost pressure. However, this engine had insufficient theoretical thermal efficiency with a low compression that was limited by knocking, as well as inadequate downsizing that included a limited boost pressure to avoid knocking. Moreover, this strategy results in a deficient amount of robustness against spray characteristics, EGR, and other engine operating conditions. This can limit the fuel-air ratio, or even the EGR rate range, but it in turn requires sophisticated fueling methods and EGR control.

Some other previous efforts include a homogenous charge compression ignition (HCCI) engine, a premixed charge compression ignition (PCCI) engine, and a full time gasoline direct-injection compression-ignition (GDCI) engine. However, in each of these concepts, it was difficult to maintain a high load operation and there was a high noise level. In addition, there was difficulty in maintaining transient control, which was caused by an insufficient tolerance of EGR, as well as other engine operating conditions.

Other examples of previous solutions are dual fuel injection systems, which include reactivity controlled compression ignition (RCCI) engines. However, these types of systems are overly complicated and include a high cost fuel supply system, as well as an inconvenient fuel charge.

Accordingly, there is a present need for a novel and efficient design for an internal combustion engine, which specifically deals with the aforementioned ignition and combustion problems.

### SUMMARY

Described herein are apparatuses and systems that utilize high temperature fuel injection to eliminate knocking within combustion systems, and more particularly internal combustion engines. In some embodiments, the combustion system of the present invention can eliminate knocking through the use of high compression ratios and high intake boost pressure. Additionally, the combustion system can have a high exhaust gas recirculation (EGR) tolerance, as well as an increased range of fuel-air ratio. By doing so, the present invention can improve the ignitability and increase the combustion speed of the system.

In some embodiments, combustion in the present invention takes place using a compression ignition (CI) process. In other embodiments, combustion can comprise a spark assisted compression ignition (SACI) process. In other embodiments, combustion can comprise both a CI process and a SACI process.

These and other aspects and advantages of the invention will become apparent to those skilled in the art from the following detailed description and the accompanying drawings, which illustrate by way of example the features of the invention.

### BRIEF DESCRIPTION OF THE DRAWINGS

FIG. 1 is a sectional schematic view of one embodiment of a combustion system incorporating features of the present invention;

FIG. 2 is a graph showing the relationship between engine speed, brake mean effective pressure (BMEP), and boost pressure in a system incorporating features of the present invention;

FIG. 3 is a graph showing the relationship between engine speed, brake mean effective pressure, and EGR rate in a second system incorporating features of the present invention;

FIG. 4 is a graph showing the relationship between brake mean effective pressure and intake temperature in a system incorporating features of the present invention;

FIG. 5A is a graph showing the relationship between intake O₂ concentration and crank angle with a low-level load in a single fuel injection embodiment of a system incorporating features of the present invention;

FIG. 5B is a graph showing the relationship between intake O₂ concentration and crank angle with a mid-level load in the single injection embodiment of a system incorporating features of the present invention;

FIG. 5C is a graph showing the relationship between intake O₂ concentration and crank angle with a high-level load in the same single injection embodiment of a system incorporating features of the present invention;

FIG. 6A is a graph showing the relationship between intake O₂ concentration and crank angle with a low-level load in a first multiple fuel injection embodiment of a system incorporating features of the present invention;

FIG. 6B is a graph showing the relationship between intake O₂ concentration and crank angle with a mid-level load in the first multiple fuel injection embodiment of a system incorporating features of the present invention;

FIG. 6C is a graph showing the relationship between intake O₂ concentration and crank angle with a high-level load in the first multiple fuel injection embodiment of a system incorporating features of the present invention;

FIG. 7A is a graph showing the relationship between intake O₂ concentration and crank angle with a low-level load in a second multiple fuel injection system incorporating features of the present invention;

FIG. 7B is a graph showing the relationship between intake O₂ concentration and crank angle with a mid-level load in the second multiple fuel injection embodiment of a system incorporating features of the present invention;

FIG. 7C is another graph showing the relationship between intake O₂ concentration and crank angle with a high-level load in the second multiple fuel injection embodiment of a system incorporating features of the present invention;

FIG. 8A is a graph showing the relationship between intake O₂ concentration and crank angle with a low-level load in a in the third multiple fuel injection embodiment of a system incorporating features of the present invention;

FIG. 8B is a graph showing the relationship between intake O₂ concentration and crank angle with a mid-level load in the third multiple fuel injection embodiment of a system incorporating features of the present invention;

FIG. 8C is a graph showing the relationship between intake O₂ concentration and crank angle with a high-level load in the third multiple fuel injection embodiment of a system incorporating features of the present invention;

FIG. 9 is a schematic sectional view of another embodiment of a combustion system incorporating features of the present invention; and

FIG. 10 is a graph showing the relationship between engine speed, brake mean effective pressure, and EGR rate in an embodiment of a system incorporating features of the present invention.

### DETAILED DESCRIPTION

Described herein are devices and assemblies that utilize high temperature fuel injection within combustion systems. More specifically, the present disclosure relates to eliminating knocking in internal combustion engines through the use of high temperatures and high compression. In some embodiments, the combustion system of the present invention can eliminate knocking by using high compression ratios and high intake boost pressure. In addition, the combustion system can have a high exhaust gas recirculation (EGR) tolerance, as well as an increased range of fuel-air ratio. As such, the present invention can increase the combustion speed and improve the ignitability of fuel in the combustion system. In some embodiments, combustion in the present invention takes place using a compression ignition (CI) process. In other embodiments, combustion can comprise a spark assisted compression ignition (SACI) process. In other embodiments, combustion can comprise both a CI process and a SACI process.

Throughout this disclosure, the preferred embodiment and examples illustrated should be considered as exemplars, rather than as limitations on the present invention. As used herein, the term “invention,” “device,” “apparatus,” “method,” “present invention,” “present device,” “assemblies,” “present apparatus” or “present method” refers to any one of the embodiments of the invention described herein, and any equivalents. Furthermore, reference to various feature(s) of the “invention,” “device,” “apparatus,” “method,” “present invention,” “present device,” “present apparatus,” “present assembly” or “present method” throughout this document does not mean that all claimed embodiments or methods must include the referenced feature(s).

It is also understood that when an element or feature is referred to as being “on” or “adjacent” to another element or feature, it can be directly on or adjacent the other element or feature or intervening elements or features may also be present. In contrast, when an element is referred to as being “directly on” or extending “directly onto” another element, there are no intervening elements present. Additionally, it is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

Furthermore, relative terms such as “outer,” “above,” “lower,” “below,” “horizontal,” “vertical” and similar terms may be used herein to describe a relationship of one feature to another. It is understood that these terms are intended to encompass different orientations in addition to the orientation depicted in the figures.

Although the terms first, second, etc. may be used herein to describe various elements or components, these elements or components should not be limited by these terms. These terms are only used to distinguish one element or component from another element or component. Thus, a first element or component discussed below could be termed a second element or component without departing from the teachings of the present invention. As used herein, the term “and/or” includes any and all combinations of one or more of the associated list items.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. For example, when the present specification refers to “a” compensator, it is understood that this language encompasses a single compensator or a plurality or array of compensators. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

It is understood that the while the present disclosure makes reference to combustion systems, and that internal combustion engines are the primary application concerned with combustion systems, apparatuses incorporating features of the present invention can be utilized with any mechanical application that has components or elements whose dimensional properties may be affected by combustion.

Embodiments of the invention are described herein with reference to different views and illustrations that are schematic illustrations of idealized embodiments of the invention. As such, variations from the shapes of the illustrations as a result, for example, of manufacturing techniques and/or tolerances are expected. Embodiments of the invention should not be construed as limited to the particular shapes of the regions illustrated herein but are to include deviations in shapes that result, for example, from manufacturing.

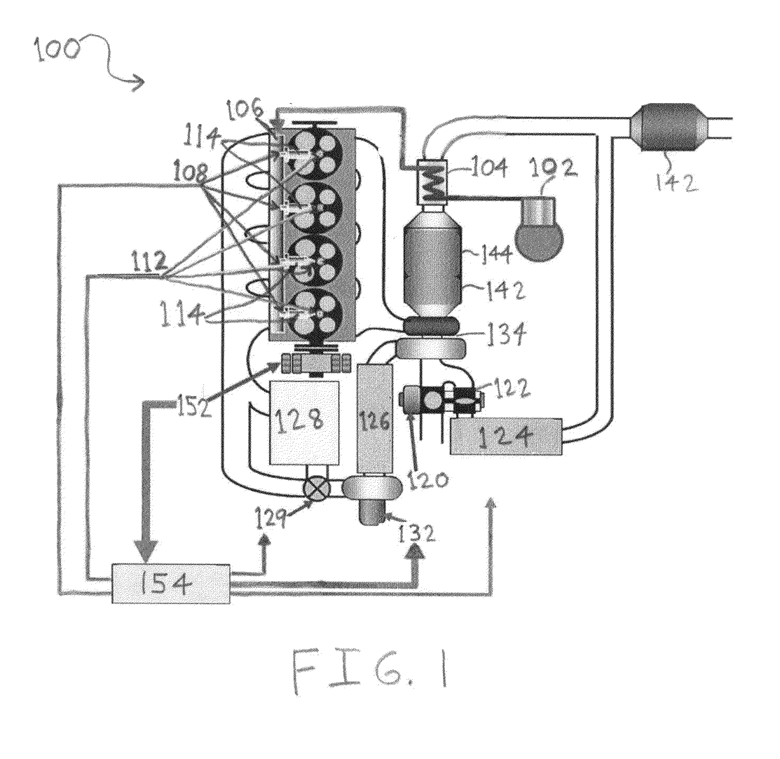

FIG. 1 is a sectional view of one embodiment of a combustion system 100 incorporating features of the present invention. Combustion system 100 comprises an injection system, a spark ignition system, an intake system with a low pressure EGR, a supercharging system, an exhaust after-treatment system, a hybrid system, and an engine control unit. Each individual system within the combustion system 100 has a function, and each system can comprise several distinct components.

For instance, FIG. 1 displays that the injection system comprises a fuel supply pump 102, a pre-heater 104, a rail 106, and one or more injectors 108. The fuel supply pump 102 can also comprise a high pressure fuel supply pump. The pre-heater 104 can be located in the exhaust passage. Furthermore, the rail 106 can comprise a heat insulator. High pressure fuel and/or high temperature fuel can be transferred from the pre-heater 104 to the rail 106. Additionally, the injectors 108 can comprise an electric actuator and a heater, which can control injection quantity, timing, and/or fuel temperature.

As shown in FIG. 1, the spark ignition system can comprise one or more igniters 112 and one or more spark plugs 114. The igniters 112 can also comprise a coil. As described below, fuel can be ignited automatically through the use of high compression and/or high temperatures, or it can be ignited by the spark plugs 114.

The intake system with a low pressure EGR can comprise a throttle valve 120, an EGR valve 122, an EGR cooler 124, a heater/cooler 126, an intercooler 128, and an intercooler by-pass valve 129. The throttle valve 120 can comprise an actuator, and the EGR valve 122 can also comprise an actuator. The heater/cooler 126 can be designed to heat or cool water, or any other liquid and/or gas. Additionally, the heater/cooler 126 can comprise a radiator. Furthermore, the heater/cooler 126 can control the intake air temperature, as well as the EGR temperature. In addition, the intercooler by-pass valve 129 can comprise an actuator.

The supercharging system can comprise an E-booster 132 and a turbocharger 134. The E-booster 132 can comprise a mechanical charger or a supercharger. Additionally, the supercharging system can comprise a turbocharger integrating motor assist compressor, or the motor assist compressor can serve as a replacement for the turbocharger 134.

The exhaust after-treatment system can comprise a lean NOₓ trap (LNT) 142 and a gasoline particulate filter (GPF) 144. The LNT 142 can comprise a three way catalyst and a NOₓ adsorbent. In the present disclosure, NOₓ can signify either of the mono-nitrogen oxides, NO or NO₂. Additionally, NOₓ can represent any other amount of oxygen atoms combined with nitrogen.

The hybrid system can comprise a motor/generator 152, a battery 154, and/or an inverter. Finally, the engine control unit can control the hybrid system, the igniter 112, the injector 108, the throttle valve 120, and/or the EGR valve 122.

The present disclosure can also include a combustion control arrangement, which can comprise either a compression ignition (CI) process and/or a spark assisted compression ignition (SACI) process. During the CI process, fuel can be injected directly into the cylinder. Additionally, fuel can be ignited automatically by using high compression and/or high temperatures. Specifically, pressure from in-cylinder gas and high fuel temperatures heated in the injector can cause ignition. Furthermore, during the CI process, combustion can comprise of a pre-mixed burn and/or diffusive combustion.

During the SACI process, fuel can also be injected directly into the cylinder. However, unlike the CI process, fuel can also be ignited by a spark plug. Accordingly, during SACI, combustion can occur in a limited area around the spark plug. As a result of this combustion, temperatures and/or pressure in the cylinder can be increased. Any un-burnt fuel can ignite through auto ignition, which is similar to the CI process, that is the result of high pressure and/or high temperatures within the cylinder. Furthermore, combustion can be completed through the processes of pre-mixed burning and/or diffusive combustion.

In some embodiments, depending upon the load level, the embodiments incorporating features of the invention can comprise different ignition processes. For example, the embodiments can comprise different load “zones,” which correspond to either a CI process or a SACI process. In some instances, a high load can correspond to CI, and a low load can correspond to SACI. Additionally, as the engine speed increases, the “zone” area corresponding to SACI can increase with a higher load. Furthermore, as the coolant temperature decreases and/or the coolant is exposed to a higher altitude, the zone area corresponding to SACI can also increase with a higher load. In some embodiments, there can be an overlap between CI and SACI zones, which can result in a hysteresis for changing transient loads.

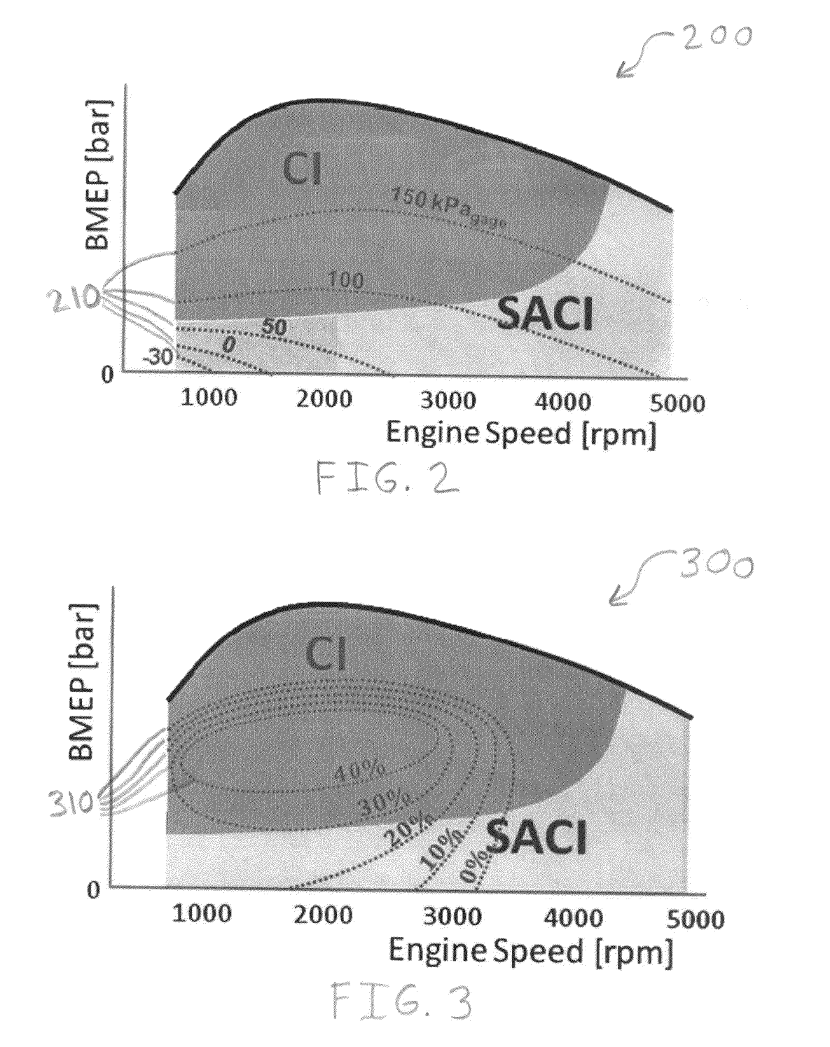

FIG. 2 displays one example of the aforementioned load zones, which comprises boost pressure control. Specifically, FIG. 2 is a graph 200 showing the relationship between engine speed, brake mean effective pressure (BMEP), and boost pressure represented by the dotted lines 210 on the graph. As mentioned above, FIG. 2 exhibits that the CI process and the SACI process can comprise different zones. In a light to medium load (i.e., lower engine speeds), the boost pressure can be increased to stabilize combustion and to increase the zone area corresponding to CI. Furthermore, in this example, the intake vacuum can be used at a low speed and/or load in order to maintain the temperature of a catalyst.

FIG. 3 is another example of the aforementioned load zones, which in this case comprises exhaust gas recirculation (EGR) control. FIG. 3 displays a graph 300 showing the relationship between engine speed, which is measured in revolutions per minute (rpm), brake mean effective pressure, which is measured in bars, and EGR rate, represented by the dotted lines 310 within the graph. FIG. 3 shows that CI and SACI can comprise different zones. In some instances, the maximum EGR rate can be in the CI combustion area. Also shown in FIG. 3, as the load (engine speed) is increased, the EGR can increase and then subsequently decrease. Additionally, within zones having a high engine speed, the EGR can decrease while simultaneous increasing the engine speed.

FIG. 4 further exhibits the CI and SACI zones, when there is an intake temperature control. Specifically, FIG. 4 is a graph 400 showing the relationship between brake mean effective pressure and intake temperature. Also shown in FIG. 4 are the ambient air temperature and the coolant temperature. In some instances, the intake air temperature and EGR temperature can be controlled by an intake cooler/heater and/or an engine coolant and/or an intercooler, which is cooled by air through an intercooler by-pass. Additionally, the intake temperature in the SACI zone can be higher than in the CI zone, which can also be true in a steady state condition.

In addition to the aforementioned zones, which can allow for either CI or SACI processes, the present disclosure can comprise a solely SACI process. In a SACI process, fuel injection and/or spark ignition can be controlled. This helps to reduce engine noise, which includes knocking, as well as avoids unstable combustion, which includes misfiring.

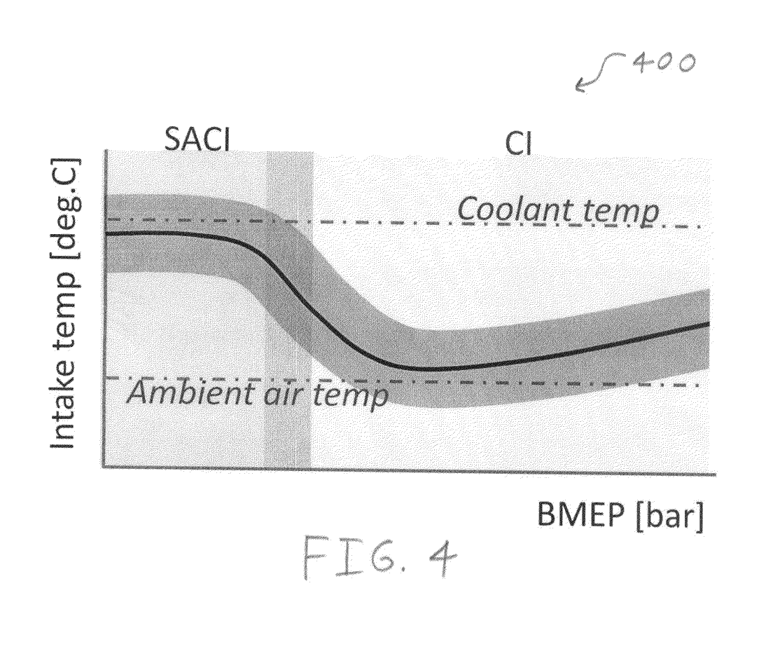

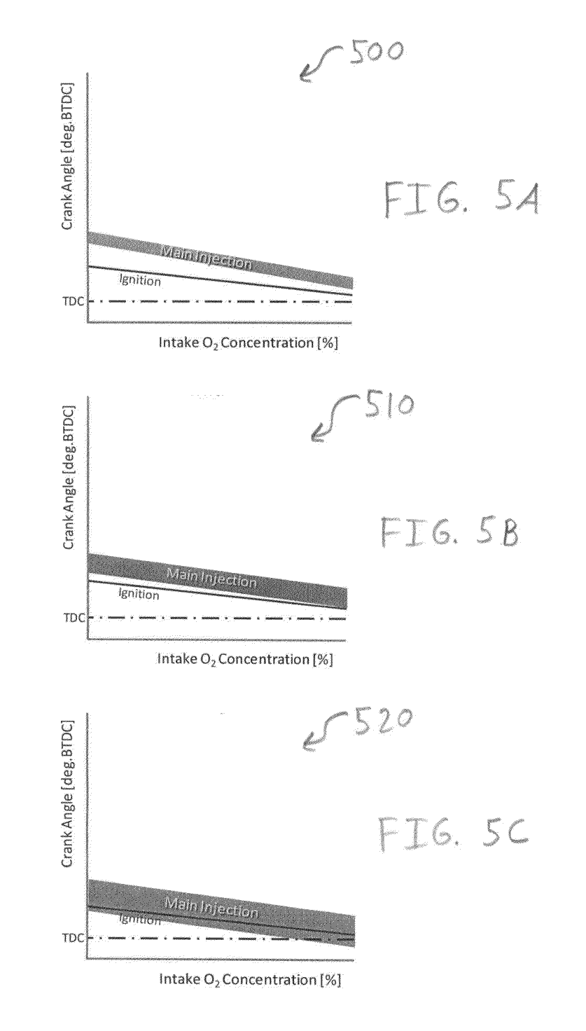

FIGS. 5A-5C display SACI when using a single injection of fuel. FIG. 5A is a graph 500 showing the relationship between intake O₂ concentration and crank angle with a low-level load; FIG. 5B is a graph 510 exhibiting the relationship between intake O₂ concentration and crank angle with a mid-level load; and FIG. 5C is a graph 520 showing the relationship between intake O₂ concentration and crank angle with a high-level load. As such, moving from FIG. 5A to FIG. 5C corresponds to an increase in load. The crank angle is measured in degrees before top dead center (BTDC), while the intake O₂ concentration is a percentage. Additionally, FIGS. 5A-5C all display a line which corresponds to top dead center (TDC) timing. Furthermore, FIGS. 5A-5C all show the main injection, as well as the ignition.

In FIGS. 5A-5C, the start of the injection can be determined by engine speed, fuel injection quantity, and/or intake O₂ concentration. At a constant engine speed, the start of the fuel injection process can be slowed down by increasing the intake O₂ concentration and maintaining a constant fuel injection quantity.

Correspondingly, the interval from the end of the injection until the spark ignition can also be determined by engine speed, fuel injection quantity, and/or intake O₂ concentration. During a constant engine speed, this interval, from the end of injection until spark ignition, can be decreased with a corresponding increased injection quantity while using the same intake O₂ concentration. Additionally, this interval can be decreased with a corresponding increased intake O₂ concentration while keeping a constant fuel injection quantity. These intervals can also include negative intervals.

The ignition timing can also be determined by engine speed, fuel injection quantity, and/or intake O₂ concentration. At a constant engine speed, the ignition timing can be decreased with a corresponding increase in intake O₂ concentration while keeping a constant fuel injection quantity.

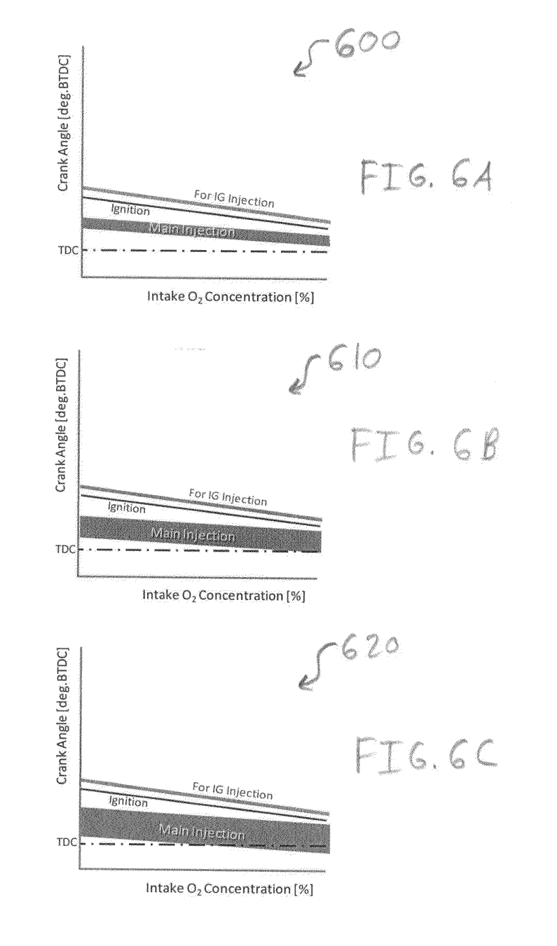

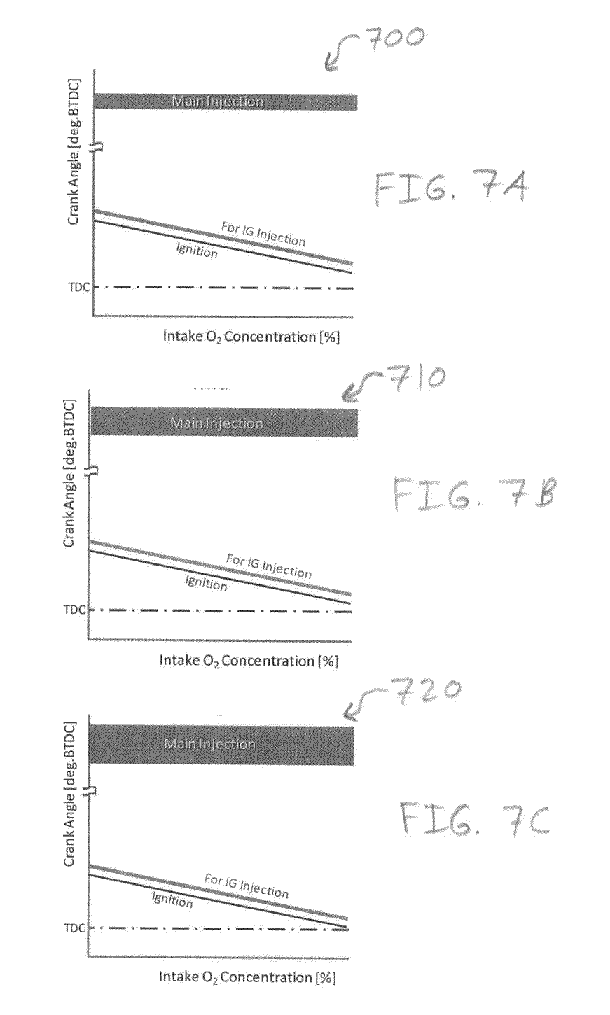

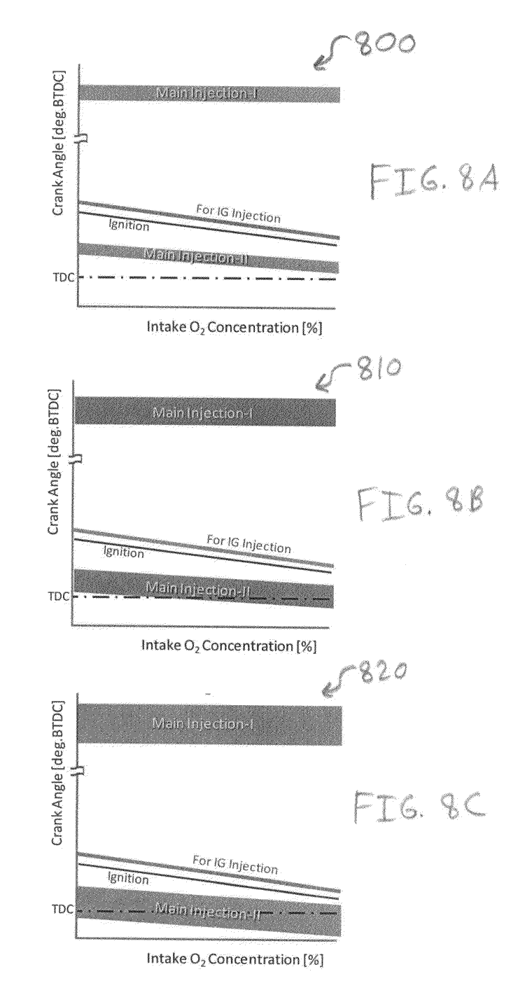

FIGS. 6A-6C display one embodiment of SACI when using multiple injections of fuel. FIG. 6A is a graph 600 showing the relationship between intake O₂ concentration and crank angle with a low-level load; FIG. 6B is a graph 610 showing the relationship between intake O₂ concentration and crank angle with a mid-level load; and FIG. 6C is a graph 620 displaying the relationship between intake O₂ concentration and crank angle with a high-level load. As such, moving from FIG. 6A to FIG. 6C corresponds to an increase in load. Once again, the crank angle is measured in degrees before top dead center (BTDC), while the intake O₂ concentration is a percentage. Additionally, FIGS. 6A-6C all display a line that corresponds to top dead center (TDC) timing. Furthermore, the graphs of FIGS. 6A-6C all show the main injection, as well as the ignition and one or more sub-injections.

In FIGS. 6A-6C, the main injection portion represents the primary injection of fuel, which can be greater than 50% of the total fuel injection quantity, while the sub-injection of fuel can be used for the spark plug ignition. Concerning the order of injections, the sub-injection can begin before the main injection. Furthermore, the spark ignition can occur between the start of the sub-injection and the main injection.

The timing of the sub-injection, used for the spark plug ignition, can be determined by engine speed, fuel injection quantity, and/or intake O₂ concentration. At a constant engine speed, the timing of the sub-injection can be slowed down through an increased intake concentration while using the same fuel injection quantity.

Ignition timing can also be determined by engine speed, fuel injection quantity, and/or intake O₂ concentration. Once again, during a constant engine speed, the ignition timing can be slowed down by increasing the intake O₂ concentration while keeping a constant fuel injection quantity.

The interval from the spark ignition until the start of the main injection can also be determined by engine speed, fuel injection quantity, and/or intake O₂ concentration. At a constant engine speed, this interval, from spark ignition until the start of the main injection, can be decreased with a corresponding increased intake O₂ concentration while maintaining a constant fuel injection quantity.

The end of the main injection can also be determined by engine speed, fuel injection quantity, and/or intake O₂ concentration. During a constant engine speed, the end of the main injection can be slowed with a corresponding increase in fuel injection quantity while keeping the intake O₂ concentration constant. Furthermore, the end of the main injection can be slowed down by increasing the intake O₂ concentration while using the same fuel injection quantity.

FIGS. 7A-7C display another embodiment of an SACI process when using multiple injections of fuel. FIG. 7A is a graph 700 showing the relationship between intake O₂ concentration and crank angle with a low-level load; FIG. 7B is a graph 710 showing the relationship between intake O₂ concentration and crank angle with a mid-level load; and FIG. 7C is a graph 720 displaying the relationship between intake O₂ concentration and crank angle with a high-level load. As such, moving from FIG. 7A to FIG. 7C corresponds to an increase in load. Once again, the crank angle is measured in degrees before top dead center (BTDC), while the intake O₂ concentration is a percentage. Additionally, FIGS. 7A-7C all display a line which corresponds to top dead center (TDC) timing. Moreover, FIGS. 7A-7C all show the main injection, as well as the ignition and one or more sub-injections.

In FIGS. 7A-7C, the main injection is the primary injection of fuel, which can be greater than 50% of the total fuel injection quantity, while the sub-injection of fuel can be used for the spark plug ignition. In regard to the order of injections, the main injection can occur before the sub-injection. Furthermore, the spark ignition can occur after the start of the sub-injection.

The timing of the sub-injection, used for ignition by the spark plug, can be determined by engine speed, fuel injection quantity, and/or intake O₂ concentration. During a constant engine speed, the timing of the sub-injection can be slowed by increasing the intake O₂ concentration while using the same quantity of fuel injection. Furthermore, the timing of sub-injection can also be slowed by increasing the quantity of fuel injection and keeping the intake O₂ concentration constant.

Ignition timing can also be determined by engine speed, fuel injection quantity, and/or intake O₂ concentration. Once again, at a constant engine speed, the ignition timing can be slowed by increasing the intake O₂ concentration while using the same quantity of fuel injection. Additionally, the ignition timing can be slowed by increasing the quantity of fuel injection and keeping the intake O₂ concentration constant.

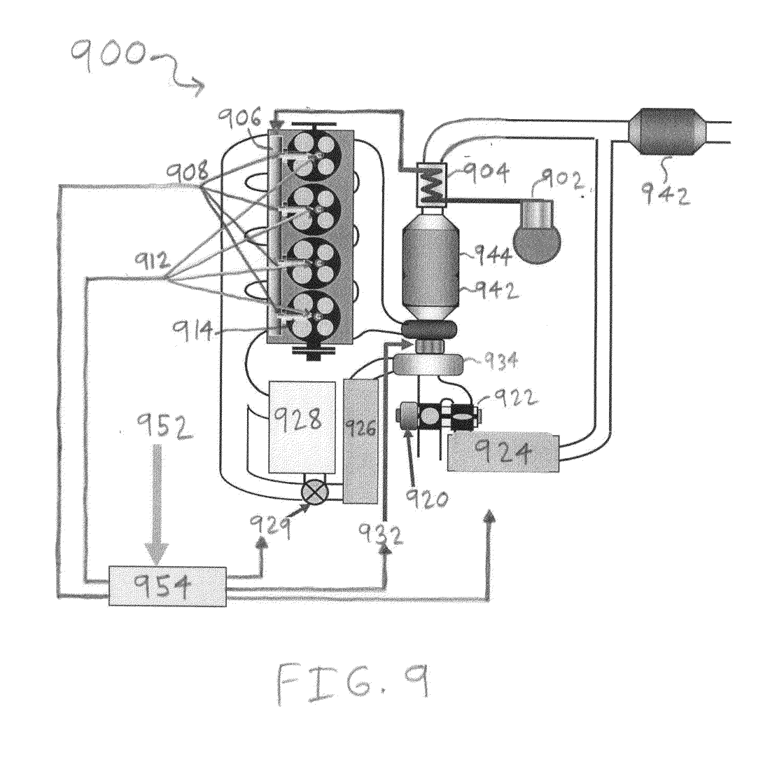

FIGS. 8A-8C display another embodiment of SACI when using multiple injections of fuel. FIG. 8A is a graph 800 showing the relationship between intake O₂ concentration and crank angle with a low-level load; FIG. 8B is a graph 810 showing the relationship between intake O₂ concentration and crank angle with a mid-level load; and FIG. 8C is a graph 820 displaying the relationship between intake O₂ concentration and crank angle with a high-level load. As such, moving from FIG. 8A to FIG. 8C corresponds to an increase in load. Once again, the crank angle is measured in degrees before top dead center (BTDC), while the intake O₂ concentration is a percentage. Additionally, FIGS. 8A-8C all display a line which corresponds to top dead center (TDC) timing. Moreover, FIGS. 8A-8C all show a first main injection, a second main injection, as well as the ignition and one or more sub-injections.

In FIGS. 8A-8C, the first main injection and the second main injection are the primary injections of fuel, which can amount to greater than 50% of the total fuel injection quantity. The sub-injection of fuel can be used for the spark plug ignition. Concerning the order of injections, the first main injection can occur first, then the sub-injection, and finally the second main injection. Furthermore, the spark ignition can occur between the sub-injection and the second main injection.

The timing of the sub-injection, used for ignition by the spark plug, can be determined by engine speed, fuel injection quantity, and/or intake O₂ concentration. At a constant engine speed, the timing of the sub-injection can be slowed by increasing the intake O₂ concentration while maintaining a constant fuel injection quantity. Furthermore, the timing of the sub-injection can also be slowed by increasing the quantity of the first main injection and keeping the intake O₂ concentration constant.

Ignition timing can also be determined by engine speed, fuel injection quantity, and/or intake O₂ concentration. Once again, during a constant engine speed, the ignition timing can be slowed by increasing the intake O₂ concentration while using a constant first main injection. Additionally, the ignition timing can be slowed by increasing the quantity of the first main injection and keeping the intake O₂ concentration constant.

The end of the second main injection can be determined by engine speed, fuel injection quantity, and/or intake O₂ concentration. At a constant engine speed, the end of the second main injection can be slowed by increasing the fuel injection quantity while keeping a constant intake O₂ concentration. Moreover, the end of the second main injection can be slowed by increasing the quantity of the intake O₂ concentration and keeping the fuel injection quantity constant.

In FIGS. 5 through 8, the main injections (the main injection, the first main injection, and/or the second main injection) are displayed as a single injection, but multiple (or split) injections can also be used.

FIG. 9 displays another embodiment of the combustion system 900 according to the present disclosure. Combustion system 900 can include injection system, a spark ignition system, an intake system with a low pressure EGR, a supercharging system, an exhaust after-treatment system, and an engine control unit. As such, when compared to the combustion systems of FIG. 1, combustion system 900 is a relatively simple system without the hybrid system. Furthermore, combustion system 900 can comprise an E-Booster that is integrated in a turbocharger and increases boost pressure with a motor assist. By doing so, this can realize a high intake pressure from a light load.

As displayed in FIG. 9, the combustion system 900 comprises a fuel supply pump 902, a heat exchanger 904, a rail 906, one or more injectors 908, one or more igniters 912, one or more spark plugs 914, a throttle valve 920, an EGR valve 922, an EGR cooler 924, a heater/cooler 926, an intercooler 928, an intercooler by-pass valve 929, an E-Booster 932, a turbocharger 934, an LNT 942, a GPF 944, an alternator 952, and a battery 954.

TABLE 1

| | Start of | | |
|---|---|---|---|
| Combustion | combustion | Main Comb Start | Main Combustion |
| SI | Spark Ignition | Spark Ignition | Flame propagation |
| SACI-B | ↑ | Compression | Premixed > Diffusive |
| | | Ignition | Comb |
| SACI-A | ↑ | ↑ | Premixed < Diffusive |
| | | | Comb |
| SACI-C | ↑ | ↑ | Premixed & Diffusive |
| | | | Comb |
| CI | Compression | ↑ | Premixed < Diffusive |
| | Ignition | | Comb |

Table 1 displays a combustion control scheme, wherein three types of combustion can be combined. Specifically, the three types of combustion are spark ignition, spark assisted combustion ignition, and compression ignition. In the spark ignition process, the combustion is started using a spark ignition, the main combustion is started using a spark ignition, and the main combustion is provided by flame propagation.

In the spark assisted combustion ignition (SACI) process, the combustion is started using a spark ignition, the main combustion is a compression ignition, the main combustion including a combination of premixed burn and diffusive combustion. In some SACI processes, premixed burn is greater than diffusive combustion. In other SACI processes, diffusive combination is greater than premixed burn. Alternatively, in other SACI processes, premixed burn and diffusive combination are of approximately equal amounts.

In the compression ignition process, the start of combustion is provided by compression ignition, main combustion is provided by compression ignition, and the main combustion includes a greater amount of diffusive combination than premixed burn.

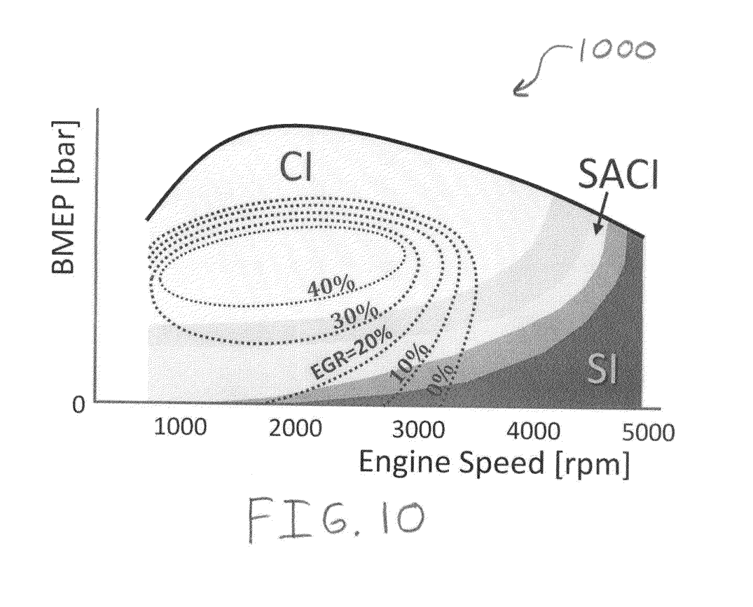

FIG. 10 is a graph 1000 showing the relationship between engine speed, which is measured in rpms, brake mean effective pressure, which is measured in bars, and EGR rate. FIG. 10 shows CI and SACI comprising different “zones.” FIG. 10 exhibits that with increasing load and engine speed, the combustion can change from spark ignition (SI) to SACI to compression ignition.

As set forth previously in the present disclosure, there can be different fuel injection pattern combinations. These fuel injection patterns can be a single injection, or a close split injection group, as displayed in FIGS. 5A-5C, or three different multiple injection patterns, or injection groups, as exhibited in FIGS. 6A-6C, 7A-7C, and 8A-8C. When a plural injection pattern is selected, then an overlap zone can be created to use hysteresis for transient loads.

Table 2 displays that, depending on the engine requirement, the embodiments incorporating features of the invention provide for the selection of 25 different patterns can be selected in a SACI zone. Referring to Table 2, a single injection corresponds with the letter “S,” the multiple injection pattern in FIGS. 6A-6C corresponds to the letter “A,” the multiple injection pattern in FIGS. 7A-7C corresponds to the letter “B,” and the multiple injection pattern in FIGS. 8A-8C corresponds to the letter “C.”

TABLE 2

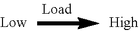

| | |
|---|---|
| 1. | S → S |
| 2. | S → A |
| 3. | S → B |
| 4. | S → C |
| 5. | S → A → B |
| 6. | S → A → C |
| 7. | S → B → A |
| 8. | S → B → C |
| 9. | S → C → A |
| 10. | S → C → B |
| 11. | A → A |
| 12. | A → B |
| 13. | A → C |
| 14. | A → B → C |
| 15. | A → C → B |
| 16. | B → A |
| 17. | B → B |
| 18. | B → C |
| 19. | B → A → C |
| 20. | B → C → A |
| 21. | C → A |
| 22. | C → B |
| 23. | C → C |
| 24. | C → A → B |
| 25. | C → B → A |

It is understood that embodiments presented herein are meant to be exemplary. Embodiments of the present invention can comprise any combination of compatible features shown in the various figures, and these embodiments should not be limited to those expressly illustrated and discussed.

Although the present invention has been described in detail with reference to certain configurations thereof, other versions are possible. Therefore, the spirit and scope of the invention should not be limited to the versions described above.

The foregoing is intended to cover all modifications and alternative constructions falling within the spirit and scope of the invention as expressed in the appended claims, wherein no portion of the disclosure is intended, expressly or implicitly, to be dedicated to the public domain if not set forth in the claims.

I claim:

1. A method for controlling an internal combustion engine, the method comprising:
operating the engine in a spark ignition zone at a low load, the low load being less than a load threshold; and
operating the engine in a compression ignition zone at a high load, the high load being greater than the load threshold,
wherein the load threshold increases with one or more of increased engine speed, reduced engine coolant temperature and reduced intake pressure.

2. The method of claim 1, wherein the load threshold exhibits hysteresis when the engine transitions from the low load to the high load or when the engine transitions from the high load to the low load.

3. The method of claim 1, further comprising:
controlling an exhaust gas recirculation (EGR) rate of the engine; and
operating the engine in the compression ignition zone at a third load, the third load being greater than the high load,
wherein:
operating the engine at the low load comprises operating the engine at a first EGR rate,
operating the engine at the high load comprises operating the engine at a maximum EGR rate, and
operating the engine at the third load comprises operating the engine at a third EGR rate, the maximum EGR rate being greater than the first EGR rate and the third EGR rate.

4. The method of claim 1, further comprising controlling an intake temperature of intake air to the engine, the intake temperature being controlled using at least an intercooler and an intercooler by-pass valve,
wherein:
operating the engine in the spark ignition zone comprises operating the engine at a first intake temperature, and
operating the engine in the compression ignition zone comprises operating the engine at a second intake temperature, the second intake temperature being lower than the first intake temperature.

5. The method of claim 1, wherein operating the engine in the spark ignition zone comprises:
injecting a main injection of fuel, the main injection of fuel having a start at a first timing and an end at a second timing; and
initiating a spark ignition of at least a portion of the injected fuel at a third timing,
wherein the first, second and third timings are based on one or more of load, engine speed, main fuel injection quantity and intake O₂ concentration.

6. The method of claim 5, wherein one or more of the first timing, the second timing and the third timing retard with increasing intake O₂ concentration.

7. The method of claim 5, wherein a difference between the second timing and the third timing decreases with one or more of increasing intake O₂ concentration and increasing main fuel injection quantity.

8. The method of claim 5, wherein a difference between the second timing and the third timing becomes negative with one or more of increasing intake O2 concentration and increasing main fuel injection quantity.

9. The method of claim 5, further comprising:
injecting a sub-injection of fuel at a fourth timing, the fourth timing being before the third timing, the third timing being before the first timing,
wherein the fourth timing is based on one or more of load, engine speed, main fuel injection quantity and intake O₂ concentration.

10. The method of claim 9, wherein one or more of the first timing, the second timing, the third timing and the fourth timing retard with increasing intake O₂ concentration.

11. The method of claim 9, wherein a difference between the third timing and the first timing decreases with increasing intake O₂ concentration.

12. The method of claim 9, wherein the second timing retards with increasing main fuel injection quantity.

13. The method of claim 5, further comprising:
injecting a sub-injection of fuel at a fourth timing, the fourth timing being before the third timing and after the second timing,
wherein the fourth timing is based on one or more of load, engine speed, main fuel injection quantity and intake O₂ concentration.

14. The method of claim 13, wherein one or more of the third timing and the fourth timing retard with one or more of increasing intake O₂ concentration and increasing main fuel injection quantity.

15. The method of claim 5, further comprising:
injecting a sub-injection of fuel at a fourth timing, the fourth timing being before the third timing and after the second timing; and
injecting a second main injection of fuel, the second main injection of fuel having a start at a fifth timing and an end at a sixth timing, the fifth timing being after the third timing,
wherein the first, second, third, fourth, fifth and sixth timings are based on one or more of load, engine speed, main fuel injection quantity, second main fuel injection quantity and intake O₂ concentration.

16. The method of claim 15, wherein one or more of the third timing and the fourth timing retard with one or more of increasing intake O₂ concentration and increasing main fuel injection quantity.

17. The method of claim 15, wherein the sixth timing retards with one or more of increasing intake O₂ concentration and increasing second main fuel injection quantity.

18. An engine control unit (ECU) comprising:
a processor; and
a computer-readable medium that stores instructions that when executed by the processor perform the method comprising:
operating an engine in a spark ignition zone at a low load, the low load being less than a load threshold; and
operating the engine in a compression ignition zone at a high load, the high load being greater than the load threshold,
wherein the load threshold increases with one or more of increased engine speed, reduced engine coolant temperature and reduced intake pressure.

19. An engine comprising:
an engine control unit (ECU) that stores instructions that when executed by the ECU perform the method comprising:
operating the engine in a spark ignition zone at a low load, the low load being less than a load threshold; and
operating the engine in a compression ignition zone at a high load, the high load being greater than the load threshold,
wherein the load threshold increases with one or more of increased engine speed, reduced engine coolant temperature and reduced intake pressure.
